(19) United States
(12) Patent Application Publication
(10) Pub. No.: US 2016/0097432 A1
(43) Pub. Date: Apr. 7, 2016

(54) One-way clutch pulley for alternator

(71) Applicant: Duo-Hu Xiong, New Taipei City (TW)

(72) Inventor: Duo-Hu Xiong, New Taipei City (TW)

(21) Appl. No.: 14/505,514

(22) Filed: Oct. 3, 2014

(51) Int. Cl. F16D 41/067

(52) U.S. Cl. CPC F16D 41/067

(57) ABSTRACT

A one-way clutch pulley for an alternator contains: a body and a driving cylinder, the body includes a plurality of recesses arranged around an outer wall thereof to accommodate plural springs and plural rolling elements. Preferably, the body and the driving cylinder are one-piece casted to enhance structural reinforcement and to lower manufacture cost.

### FIELD OF THE INVENTION

The present invention relates to a one-way clutch pulley for an alternator which contains a body and a driving cylinder one-piece casted to enhance structural reinforcement and lower manufacture cost.

### BACKGROUND OF THE INVENTION

With reference to FIGS. 1 to 6, each of two conventional one-way clutch pulleys A for an alternator contains: a plastic holding loop A1, a plurality of rolling elements A2, plural resilient pieces A3, two shaft bearings A4 (as shown in FIGS. 1 to 3) or two ball bearing A4 (as illustrated in FIGS. 4 to 6), a sleeve A5, and a holder A6; wherein the plastic holding loop A1 has plural orifices A11 defined around an outer wall thereof.

Referring to FIGS. 2-3 and 5-6, each rolling element A2 and each resilient piece A3 are accommodated in each orifice A11 of the plastic holding loop A1, and two ends of each shaft bearing A4 or each ball bearing A4 are mounted on two ends of the plastic holding loop A1 which is fixed in the sleeve A5, and the holder A6 is inserted into the plastic holding loop A1 and each shaft bearing A4 or each ball bearing A4.

However, such two conventional one-way clutch pulleys A have disadvantages as follows:

1. Each conventional one-way clutch pulley A contains lots of components which are assembled troublesomely, thus causing high production cost.

2. The plastic holding loop A1 is broken easily at high temperature, thereby increasing maintenance cost.

3. Since each orifice A11 is small, and each resilient piece A3 is in a small size and has poor elasticity, each conventional one-way clutch pulley A operates roughly.

The present invention has arisen to mitigate and/or obviate the afore-described disadvantages.

### SUMMARY OF THE INVENTION

The primary object of the present invention is to provide a one-way clutch pulley for an alternator which contains a body and a driving cylinder one-piece casted to enhance structural reinforcement and lower manufacture cost.

To obtain the above object, a one-way clutch pulley for an alternator provided by the present invention contains: a body and a driving cylinder, the body includes a plurality of recesses arranged around an outer wall thereof to accommodate plural springs and plural rolling elements.

Preferably, the body and the driving cylinder are one-piece casted to enhance structural reinforcement and to lower manufacture cost.

### BRIEF DESCRIPTION OF THE DRAWINGS

FIG. 1 is a perspective view of a conventional one-way clutch pulley for an alternator.

FIG. 2 is another perspective view of the conventional one-way clutch pulley for the alternator.

FIG. 3 is also another perspective view of the conventional one-way clutch pulley for the alternator.

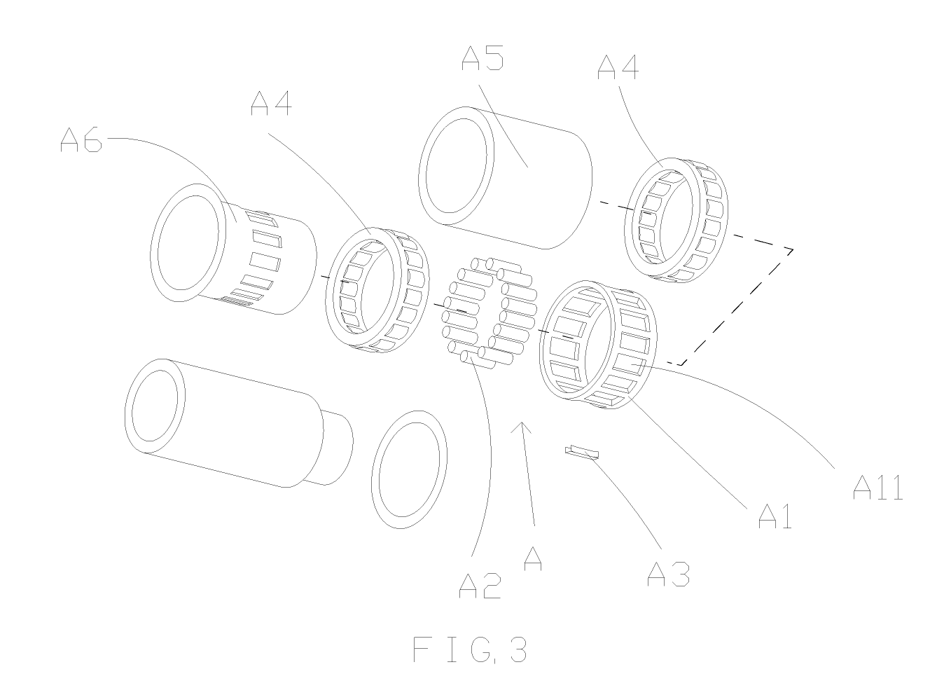

FIG. 4 is a cross sectional view of another conventional one-way clutch pulley for an alternator.

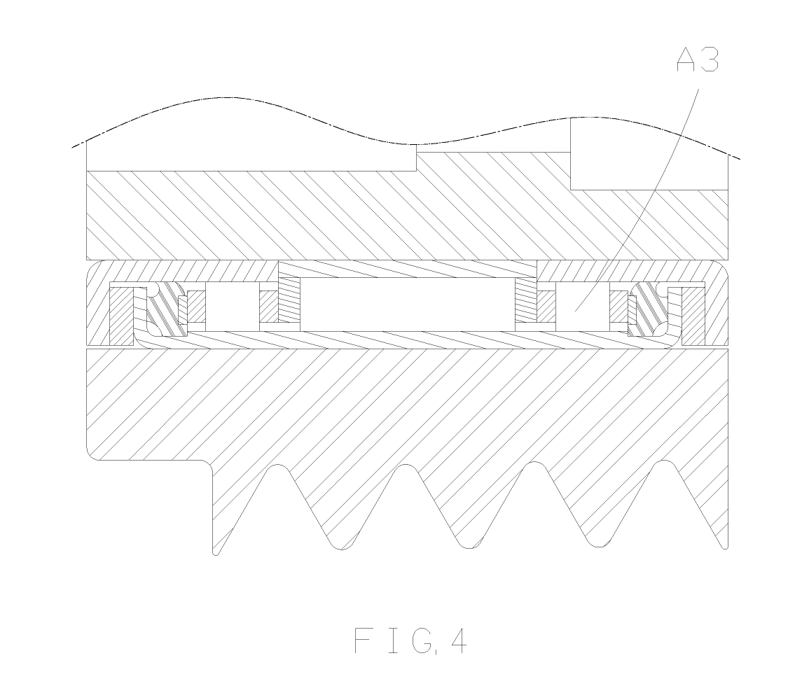

FIG. 5 is another cross sectional view of another conventional one-way clutch pulley for the alternator.

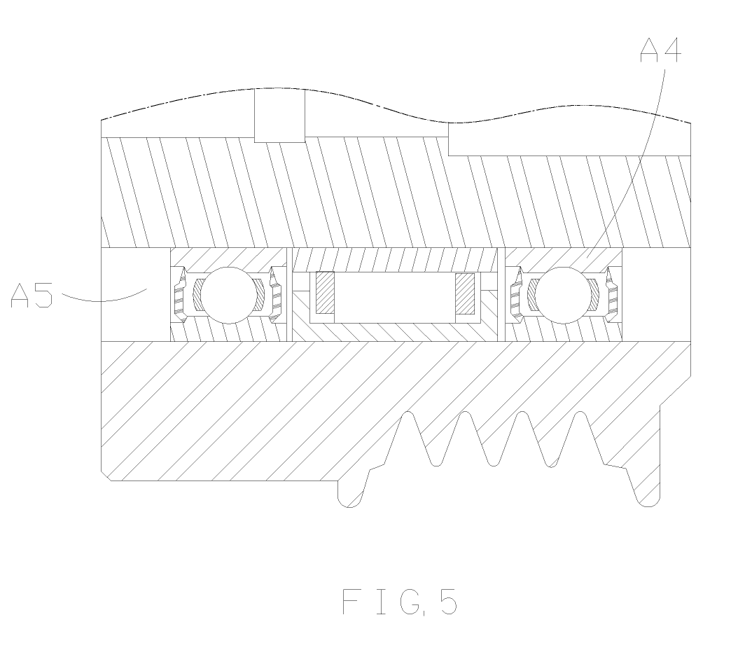

FIG. 6 is a cross-sectional perspective view of another conventional one-way clutch pulley for the alternator.

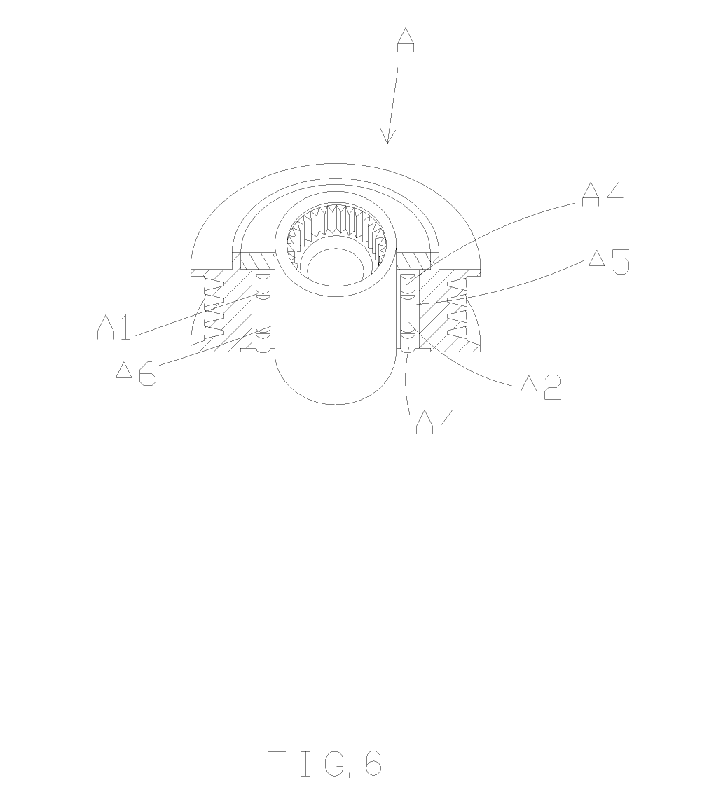

FIG. 7 is a perspective view showing the exploded components of a one-way clutch pulley for an alternator according to a preferred embodiment of the present invention.

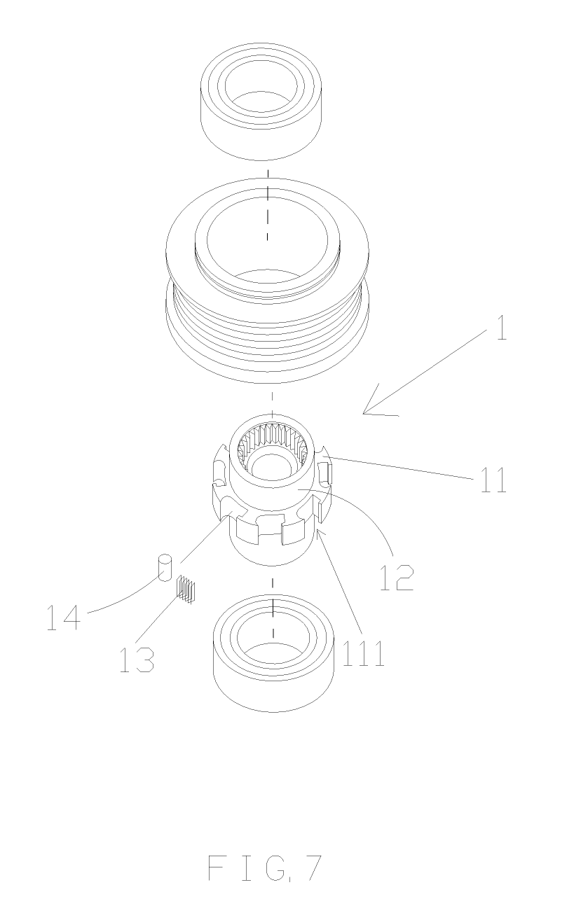

FIG. 8 is a cross sectional view showing the assembly of the one-way clutch pulley for the alternator according to the preferred embodiment of the present invention.

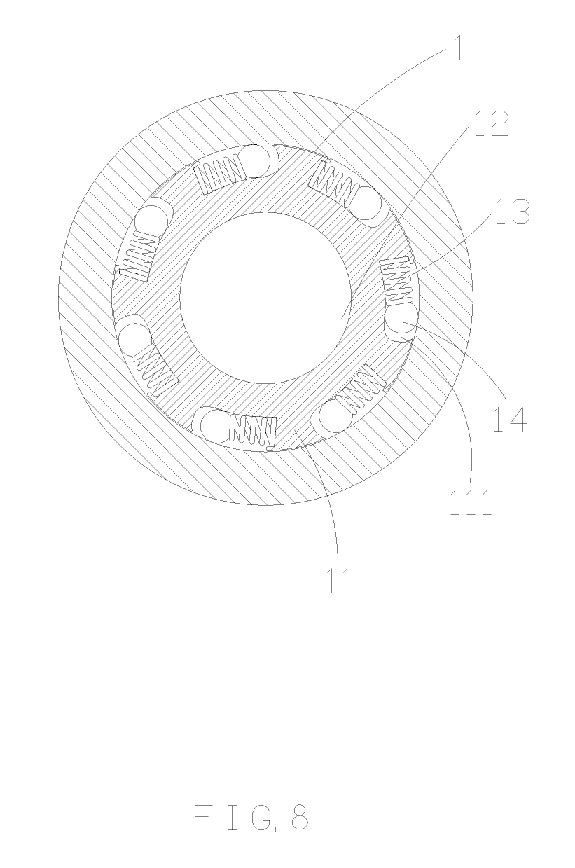

FIG. 9 is a cross-sectional perspective view showing the assembly of a part of the one-way clutch pulley for the alternator according to the preferred embodiment of the present invention.

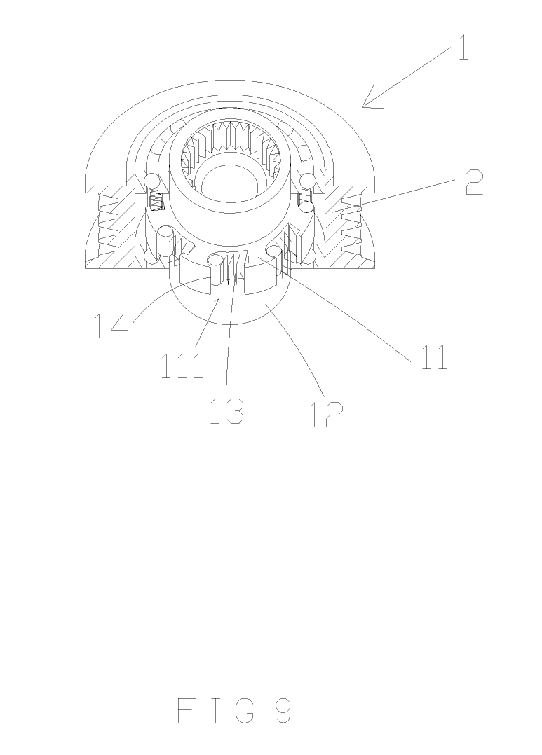

FIG. 10 is a cross sectional view showing the operation of a part of the one-way clutch pulley for the alternator according to the preferred embodiment of the present invention.

FIG. 11 is another cross sectional view showing the operation of a part of the one-way clutch pulley for the alternator according to the preferred embodiment of the present invention.

FIG. 12 is also another cross sectional view showing the operation of a part of the one-way clutch pulley for the alternator according to the preferred embodiment of the present invention

FIG. 13 is still another cross sectional view showing the operation of a part of the one-way clutch pulley for the alternator according to the preferred embodiment of the present invention.

### DETAILED DESCRIPTION OF THE PREFERRED EMBODIMENTS

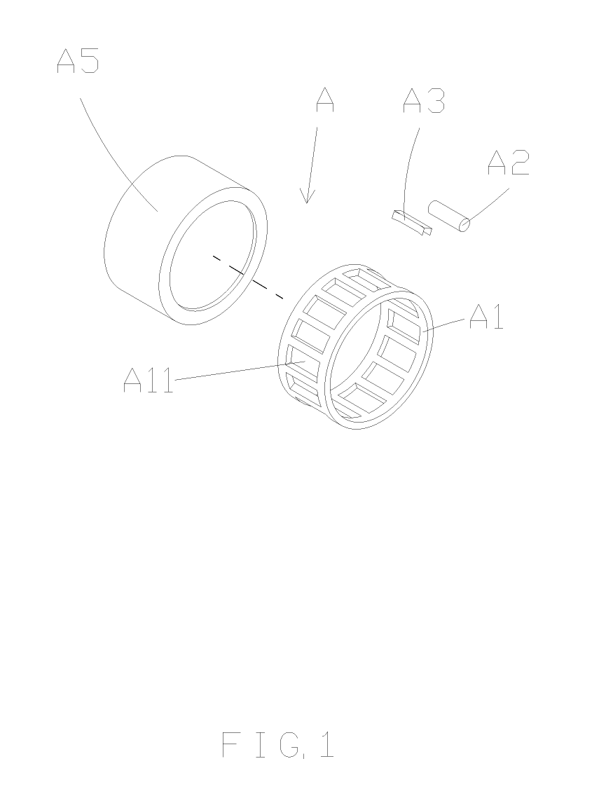

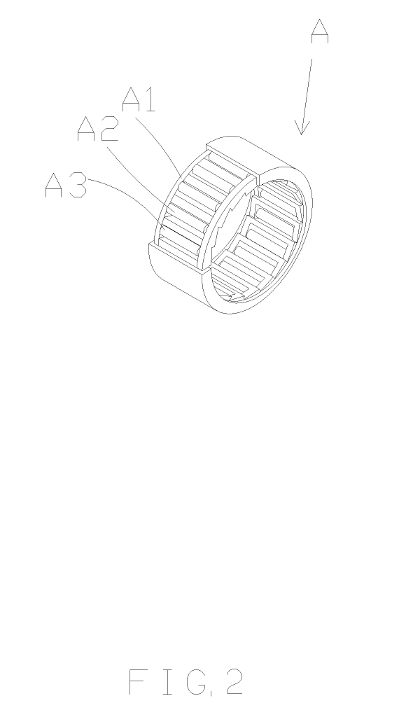

Referring to FIGS. 1 and 2, a one-way clutch pulley 1 for an alternator according to a first embodiment of the present invention comprises: a body 11 and a driving cylinder 12 which are one-piece casted, the body 11 includes a plurality of recesses 11 arranged around an outer wall thereof to accommodate plural springs 13 and plural rolling elements 14.

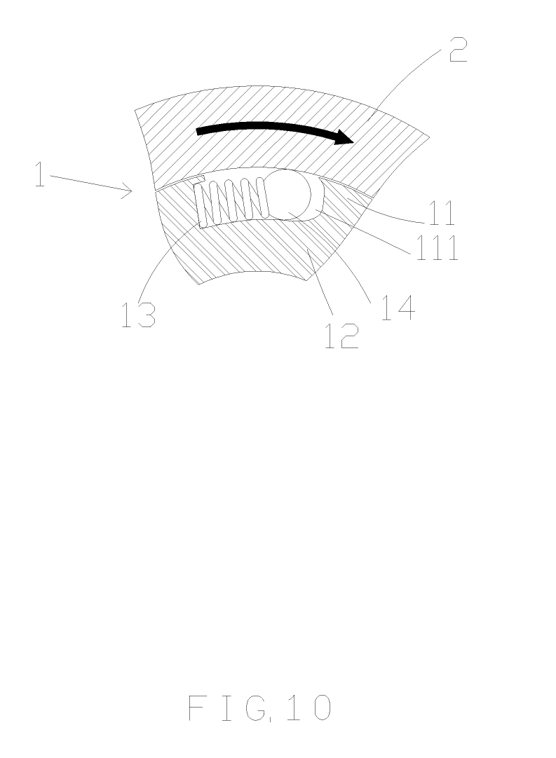

Referring to FIGS. 10 to 13, in operation, a car engine drives a belt, the belt drives a belt pulley 2 to rotate, and the belt pulley 2 drives the one-way clutch pulley 1 to rotate, such that a length of each spring 13 is equal to an installation length so that each spring 13 abuts against each rolling element 14, and each rolling element 14 is biased against the belt pulley 2, as shown in FIG. 10.

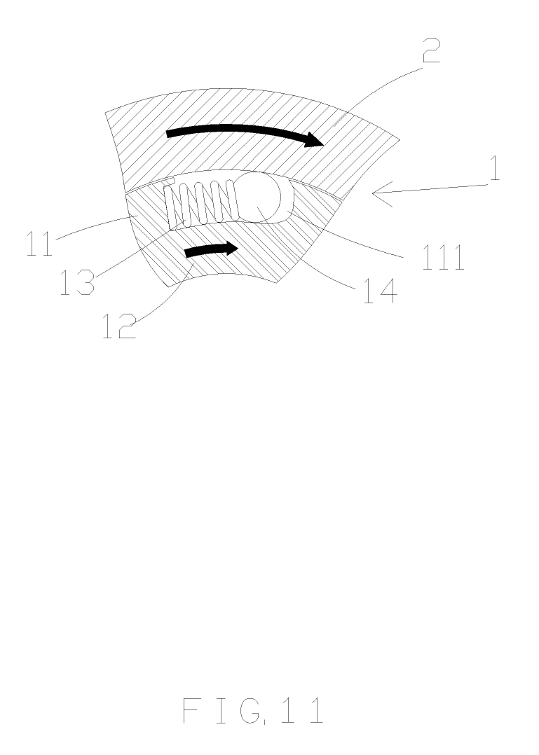

When each rolling element 14 is biased against the belt pulley 2, the driving cylinder 12 is driven by each rolling element 14 to rotate, and the length of each spring 13 is also equal to the installation length, as illustrated in FIG. 11.

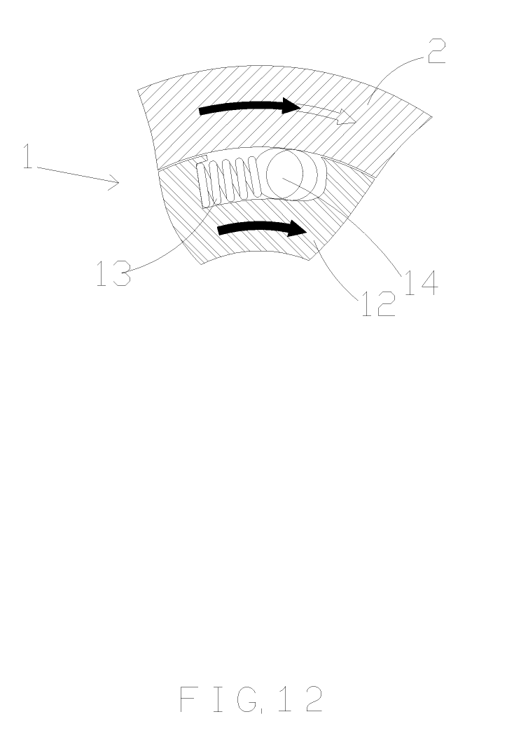

When a rotating speed of the belt pulley 3 reduces with a speed deceleration of the car engine, the belt drives the clutch pulley 1 to rotate slowly, but plural rotors in an alternator produces gravitational acceleration to rotate at a high speed, as shown in FIG. 12, such that each rolling element 14 rolls to press each spring 13 and does not force the driving cylinder 12 thus rotating the driving cylinder 12 idly to avoid vibration.

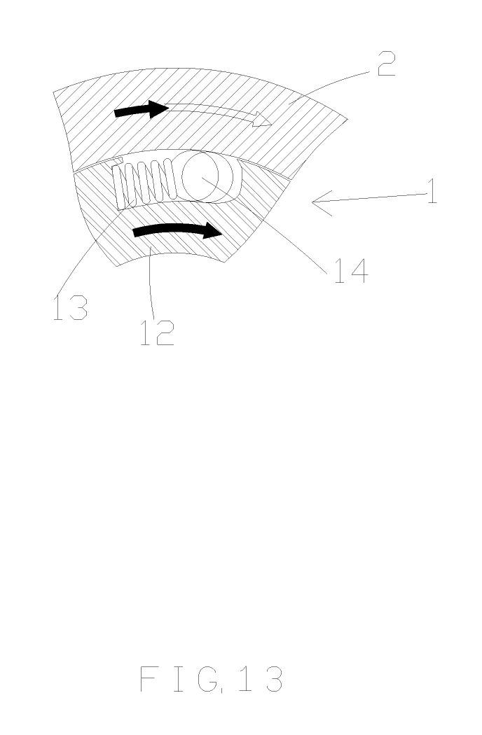

When the car engine accelerates or runs at around a rotating speed of the alternator, each spring 13 is forced gently and each rolling element 14 rolls, such that the length of each spring 13 recovers to the installation length so that each spring 13 drives the driving cylinder 12 to rotate, as illustrated in FIG. 13.

While the preferred embodiments of the invention have been set forth for the purpose of disclosure, modifications of the disclosed embodiments of the invention and other embodiments thereof may occur to those skilled in the art. Accordingly, the appended claims are intended to cover all embodiments which do not depart from the spirit and scope of the invention.

What is claimed is:

1. A one-way clutch pulley for an alternator comprises: a body and a driving cylinder, the body including a plurality of recesses arranged around an outer wall thereof to accommodate plural springs and plural rolling elements.

2. The one-way clutch pulley for the alternator as claimed in claim 1, wherein the body and the driving cylinder are one-piece casted.
